(19) United States
(12) Patent Application Publication
(10) Pub. No.: US 2006/0133294 A1
(43) Pub. Date: Jun. 22, 2006

(54) Apparatus and method for measuring capacity of server

(75) Inventor: Gyu-baek Kim, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/295,538

(22) Filed: Dec. 7, 2005

(30) Foreign Application Priority Data
Dec. 22, 2004 (JP) 10-2004-0110346

(51) Int. Cl. H04J 1/16

(52) U.S. Cl. 370/252

(57) ABSTRACT

An apparatus and a method for measuring a capacity of a server are provided. A plurality of virtual clients matched to a small number of threads are generated to minimize a context switching overhead and a traffic similar to an actual network traffic is generated and transmitted to the server. The apparatus includes a packet generating unit, an instance unit which generates a virtual client constituting a session with the server, a thread unit which stores a thread to transmit the generated packet through the constituted session, and a synchronization unit which processes scheduling between the constituted session and the thread.

### CROSS-REFERENCE TO RELATED APPLICATION

This application claims priority from Korean Patent Application No. 10-2004-0110346 filed on Dec. 22, 2004 in the Korean Intellectual Property Office, the disclosure of which is incorporated herein by reference in its entirety.

### BACKGROUND OF THE INVENTION

1. Field of the Invention

Apparatuses and methods consistent with the present invention relate to measuring a capacity of a server, and more particularly, to measuring a capacity of a server in which a plurality of virtual clients matched to a small number of threads are generated to minimize a context switching overhead and a traffic similar to an actual network traffic is generated and transmitted to a server.

2. Description of the Related Art

A client-server structure represents a role relationship between two computer programs. A client is a program requesting another program of a service, and a server is a program that responds to the request. A client-server concept is applicable in a single computer and is more meaningfully applicable in a network environment. A client-server structure on a network provides a convenient means for connecting programs distributed throughout other regions with one another.

In general client-server structures, a server serves to provide information to a client. As such, server capacity is one of important network features. In particular, transmission and reception and processing of a huge amount of data are basic requirements of the server.

Thus, in order to effectively establish a server, a server manager may perform capacity planning.

The capacity planning is performed through previous investigation of the amount of data, the number of clients, and a network environment. To investigate the detailed configuration of the server, simulation is preferably performed.

However, even though the simulation using an actual client is the most accurate capacity measurement, due to costs and construction space, server capacity measurement using a virtual client is generally performed.

FIG. 1 is a conceptual diagram of server capacity measurement using a conventional apparatus for measuring a capacity of a server.

The virtual client is generated by one test client 110. The test client 110 allows a plurality of virtual clients generated by capacity measurement of a server 120 to communicate with the server 120.

As such, a server manager can measure the capacity of the server 120 using the state of the server 120 that responds to the number of virtual clients generated and the amount of data transmitted and received.

A method of generating a virtual client using the test client 110 includes a method of generating a large amount of traffic, a method of allocating one thread to one virtual client, and a method of allocating one process to one virtual client.

In the method of generating a large amount of traffic, only a large amount of traffic generated by a small number of virtual clients is processed by the server. Thus, a test for a context switching overhead which is a primary overhead element of the actual server 120 is not performed.

In the method of allocating one thread or process to one virtual client, it is proper to perform the test for a context switching overhead. However, to construct a test client for generating a sufficient number of threads or processes, a hardware environment with high specification is needed.

U.S. Pat. No. 6,324,492 entitled “Server Stress Testing Using Multiple Concurrent Client Simulation”, describes that one of a variety of states stored in a virtual client is selected to be transmitted to a send data thread, data transmitted to a socket is received by a thread data receiver through each data buffer and a response time of a server is checked, thereby testing capacity of the server. In this case, two threads such as send data thread and receive data thread are used. Due to frequent switching between threads, a context switching overhead is generated so that it is difficult to effectively test a capacity of the server.

### SUMMARY OF THE INVENTION

The present invention provides an apparatus and a method for measuring a capacity of a server in which a plurality of virtual clients matched to a small number of threads are generated to minimize a context switching overhead so that the large amount of the virtual clients communicates with a server.

The present invention also provides an apparatus and a method for measuring a capacity of a server which allows a test client to transmit a traffic similar to an actual network traffic to a server.

The above stated aspects as well as other aspects, features and advantages, of the present invention will become clear to those skilled in the art upon review of the following description.

According to an aspect of the present invention, there is provided an apparatus for measuring a capacity of a server, the apparatus including a packet generating unit which generates a packet, an instance unit which generates a virtual client that constitutes a session with the server, a thread unit which stores a thread to transmit the generated packet through the constituted session, and a synchronization unit which processes scheduling between the constituted session and the thread.

According to another aspect of the present invention, there is provided a method of measuring a capacity of a server, the method including generating a packet, generating a virtual client that constitutes a session with the server, generating and storing a thread, processing scheduling between the constituted session and the thread; and transmitting the generated packet to the server through the constituted session.

### BRIEF DESCRIPTION OF THE DRAWINGS

The above and other features and advantages of the present invention will become more apparent by describing in detail preferred embodiments thereof with reference to the attached drawings in which:

FIG. 1 is a conceptual diagram of server capacity measurement using a conventional apparatus for measuring a capacity of a server;

FIG. 2 is a conceptual diagram of server capacity measurement using an apparatus for measuring a capacity of a server according to an exemplary embodiment of the present invention;

FIG. 3 is a block diagram of an apparatus for measuring a capacity of a server according to an exemplary embodiment of the present invention;

FIG. 4 is a block diagram of a packet generating unit according to an exemplary embodiment of the present invention;

FIG. 5 is an exemplary diagram of a table of a packet stored in each model according to an exemplary embodiment of the present invention;

FIG. 6 is a diagram showing a structure of a class of an application program for measuring a capacity of a server according to an exemplary embodiment of the present invention;

FIG. 7 shows a packet transmitted through each session according to an exemplary embodiment of the present invention;

FIG. 8 is a flowchart illustrating a method of measuring a capacity of a server using the apparatus for measuring a capacity of a server according to an exemplary embodiment of the present invention; and

FIG. 9 is a flowchart illustrating a procedure of generating a packet according to an exemplary embodiment of the present invention.

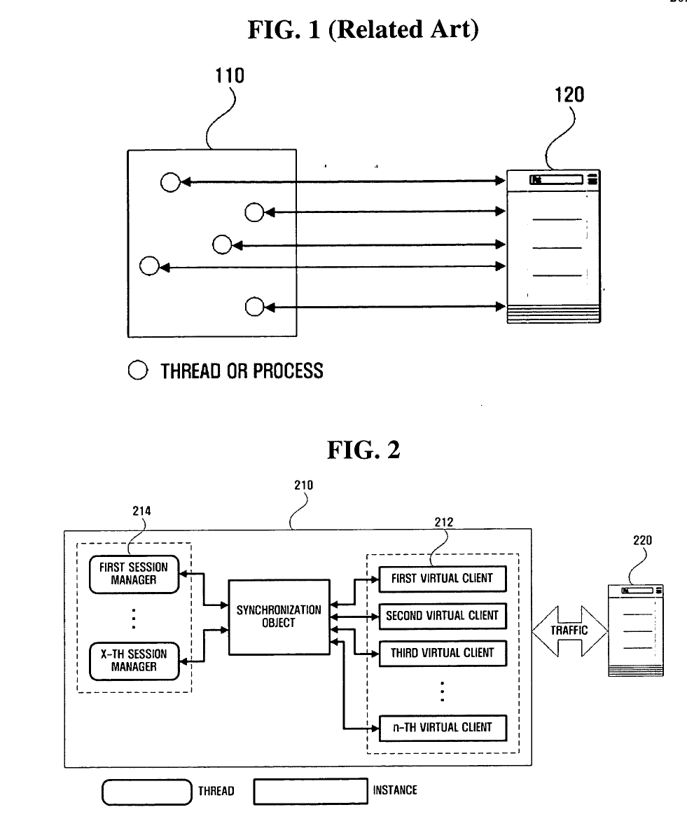

### DETAILED DESCRIPTION OF THE INVENTION

The present invention will now be described more fully with reference to the accompanying drawings, in which exemplary embodiments of this invention are shown. Advantages and features of the present invention and methods of accomplishing the same may be understood more readily by reference to the following detailed description of exemplary embodiments and the accompanying drawings. The present invention may, however, be embodied in many different forms and should not be construed as being limited to the exemplary embodiments set forth herein. Rather, these embodiments are provided so that this disclosure will be thorough and complete and will fully convey the concept of the invention to those skilled in the art, and the present invention will only be defined by the appended claims. Like reference numerals refer to like elements throughout the specification.

Before explaining the present invention, terms used in the specification will now be described briefly.

Input output completion ports (IOCPs) are ports for notifying completion of input output of an apparatus using asynchronous input and output and include an optimized thread pooling technology in addition to fast input output notification.

IOCPs are connected to a plurality of working threads (session managers) and perform an input and output work. The working threads are used to insert data, in which input and output is completed, into an IOCP queue and to process the data.

In this case, the working threads waiting in a waiting thread queue are extracted in an order of last-in-first-out (LIFO) according to notification of input and output completion of an IOCP, and process data from an IOCP queue.

The reason why the working threads are extracted in an order of LIFO is that threads in work are made to work again to reduce context switching of a central processing unit (CPU). As such, an overhead caused by context switching can be reduced.

In addition, unlike a general socket that separately operates a buffer of an operating system (OS) and a buffer of an application, IOCP allows an OS and an application to refer to the position of a memory of the same buffer so that a working speed can be increased.

Here, context switching is to switch one program into another program. In an application using multi-thread, switching between threads corresponds to context switching, which results in an overhead of a CPU.

The present invention will now be described more fully with reference to the accompanying drawings, in which exemplary embodiments of the invention are shown.

FIG. 2 is a conceptual diagram of server capacity measurement using an apparatus for measuring a capacity of a server according to an exemplary embodiment of the present invention.

A web server, a home network server, an online game server, or other servers for managing a large amount of clients may be superior to a server for managing a small amount of clients in an aspect of capacity. Here, capacity includes hardware elements such as a processing speed of a CPU, a capacity of a memory, and a capacity of a spare hard disc and a software element which is an application program that effectively manages clients.

The capacity of the server is not determined only by the number of clients or the amount of traffic and thus can be checked through a test with a large amount of clients on an actual network. However, the test with a large amount of clients is impossible in actuality. A network environment similar to reality may be provided by the server so that the capacity of the server can be measured.

Here, in the network environment similar to reality, the server receives a similar traffic to actual client-server driving in a state where a session is connected to a large amount of clients.

In this case, to simulate the clients, a large amount of virtual clients should be generated, the server and the session should be maintained, and traffic should be transmitted through the session. This work is generally performed through a multi-thread technique that matches one thread to one client.

However, context switching is generated in client simulation using multi-thread in proportion to a working amount. Context switching causes an overhead of a CPU, and thus requires high hardware specification of the apparatus for measuring a capacity of the server.

Thus, an algorithm for reducing an overhead caused by context switching and transmission of a packet similar to the flow of an actual packet are applied to the apparatus 210 for measuring a capacity of the server according to an exemplary embodiment of the present invention.

The basic structure of the apparatus 210 for measuring a capacity of the server according to an exemplary embodiment of the present invention includes a virtual client 212 generated in large quantities and a session manager 214 that transmits a generated packet to a server 220.

Here, the virtual client 212 corresponds to one instance and constitutes a session with the server 220. The virtual client 212 may be generated to the number required for measuring a capacity of the server 220.

The session manager 214 as a thread inserts a generated packet into a packet queue and transmits a packet output from the packet queue to the server 220 through the session constituted between the virtual client 212 and the server 220.

Unlike the conventional apparatus for measuring a capacity of a server in which one thread is matched to one virtual client, the session manager 214 is called only when a work such as packet insertion or packet transmission is required and performs the work.

The session manager 214 is stored in the thread queue. Since the thread queue is formed in a stack shape, the session manager 214 is managed in an order of LIFO. By using this, a probability that the session manager 214 that has performed work lately is selected to work again increases.

Thus, the apparatus 210 for measuring a capacity of the server 220 can transmit a packet through a large amount of session in a state where the occurrence number of context switching is reduced.

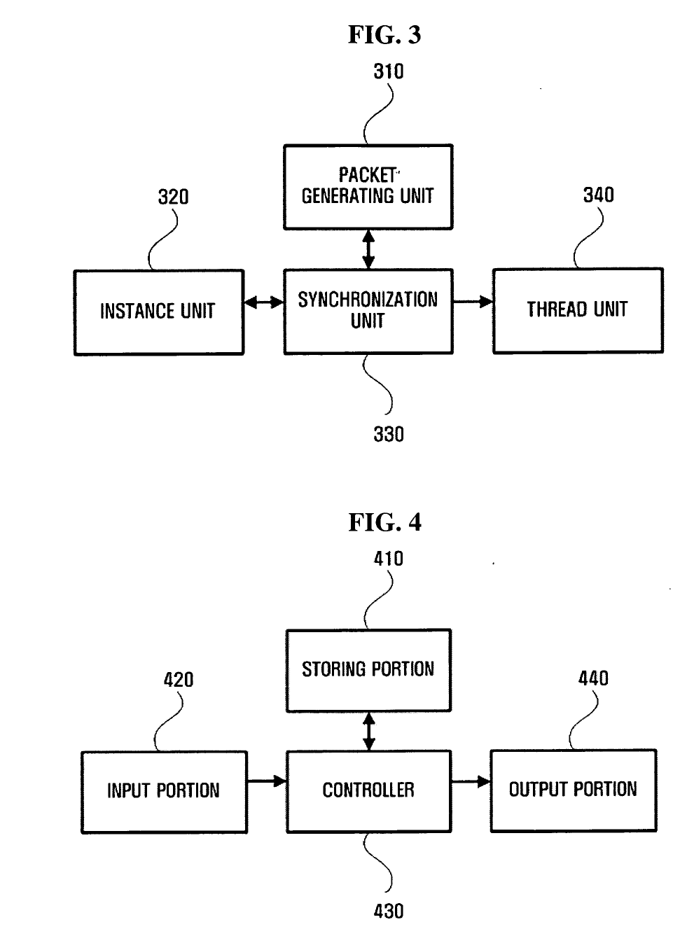

FIG. 3 is a block diagram of an apparatus for measuring a capacity of a server according to an exemplary embodiment of the present invention.

The apparatus of FIG. 3 includes a packet generating unit 310, an instance unit 320, a thread unit 340, and a synchronization unit 330.

The packet generating unit 310 generates a packet having a predetermined size.

In general, in the client-server network structure, the shape of a traffic provided by the server is not uniform and the undulation of traffic varies according to several factors. The traffic follows a predetermined pattern than implementation using the number of transmission and size of a packet selected randomly. In an exemplary embodiment of the present invention, a principle of self-similarity is used.

Self-similarity is that there is similarity between macroscopic shape and microscopic shape in a series of signals. There have been results of study supporting that a network traffic has self-similarity (Literature cited 1: M. Taqqu and V. Teverosky, “Is network traffic self-similar or multifractal?”, Fractals, Vol. 5, No. 1, 1997. Literature cited 2: W. E. Leland, et al., “On the self-similar nature of Ethernet traffic”, IEEE/ACM Transactions on Networking, 1994).

According to self-similarity, a web server, a home network server, an online game server, and the like show different traffic shapes according to kinds. When only each traffic is observed, there is similarity between the entire traffic (macroscopic shape) and a specific partial traffic (microscopic shape).

By using this, the shape of a characteristic traffic can be extracted according to a type of a server. The packet generating unit 310 generates and outputs a packet to form such a traffic shape.

The packet generated and output by the packet generating unit 310 is inserted into the packet queue.

The instance unit 320 generates an instance, that is, a virtual client, for constituting a session with the server.

Here, each virtual client 212 constitutes a session with the server 220. The number of virtual clients 212 may be properly selected according to the type of the server 220 and other conditions.

The thread unit 340 stores a thread, that is, the session manager 214. The session manager 214 includes a packet transmission session manager for transmitting a packet generated by the packet generating unit 310 through the session constituted by the virtual client 212 and a packet insertion session manager for inserting a packet generated by the packet generating unit 310 into the packet queue.

The packet insertion session manager or the packet transmission session manager is selected among one or more threads so that its role is performed by the synchronization unit 330. The number of threads may be properly selected in consideration of the number of CPUs, the number of packet processing, or the size of a packet. Here, the number of threads may be one per CPU.

The synchronization unit 330 processes scheduling between the sessions constituted by the virtual client 212 and the session manager 214.

Scheduling performed by the synchronization unit 330 relates to output of the threads stored in the thread unit 340. For example, in case of packet transmission performed by the specific virtual client 212, an effective thread (the session manager 214) of the threads stored in the thread unit 340 transmits the packet.

The thread unit 340 corresponds a thread queue and has a stack shape. Thus, the output order of the session manager 214 of the thread unit 340 is determined in an order of LIFO.

For example, when a first session manager, a second session manager, and a third session manager are generated and sequentially stored in the thread unit 340 (when the first session manager has been first input), if the packet generating unit 310 outputs a packet, the synchronization unit 330 extracts the session manager 214 that has been last input to the thread unit 340.

Since the last input session manager 214 is the third session manager, the synchronization unit 330 makes the third session manager insert the packet output from the packet generating unit 310 into the packet queue and inputs the third session manager back to the thread unit 340. In this case, if a packet is output from the packet queue, the synchronization unit 330 extracts the last input session manager 214 from the thread unit 340. When the third session manager has completed the packet insertion, the synchronization unit 330 makes the third session manager transmit the packet output from the packet queue to the server 220, and when the third session manager is still performing the packet insertion, the synchronization unit 330 makes the second session manager in a standby state in a next order transmit the packet output from the packet queue to the server 220.

FIG. 4 is a block diagram of a packet generating unit according to an exemplary embodiment of the present invention.

The packet generating unit 310 includes a storing portion 410, an input portion 420, a controller 430, and an output portion 440.

The storing portion 410 stores a pattern of a packet per model.

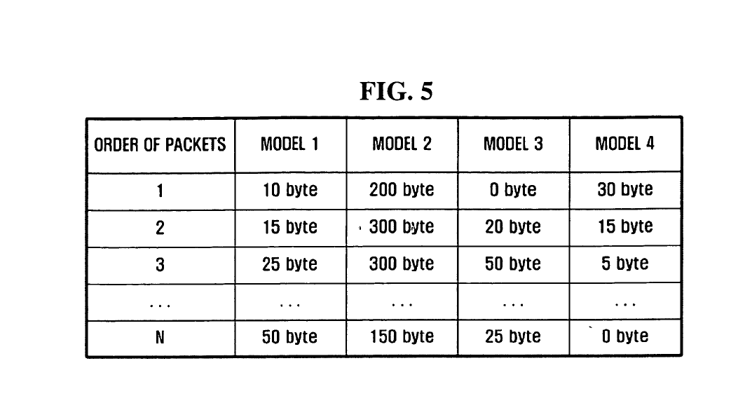

The pattern of a packet per model may be stored in a form of a table shown in FIG. 5. Information according to the output order of a packet may be included.

For example, the size of a packet according to the output order can be indicated, as shown in FIG. 5, only the size of an initial packet and differences between packets can be indicated in the table, and mathematical algorithms can be indicated.

The input portion 420 receives the type of model which is packet pattern information, the order of packets, and the session number.

The type of the model, the order of packets, and the number for sessions received by the input portion 420 are transmitted to the controller 430. The controller 430 extracts corresponding packet information by referring to a packet table stored in the storing unit 410. Then, the controller 430 generates a packet corresponding to the packet information and outputs the generated packet to the output portion 440.

For reference, in FIG. 2, when the virtual client 212 is dependent on the session manager 214 and a packet is dependent on the virtual client 212, since the session manager 214 can know the virtual client 212 that makes the packet generating unit 310 generate the packet, the session number can be omitted.

In addition, the generated packet may be data comprised of arbitrary value or data having predetermined contents (graphic data in case of an online game server).

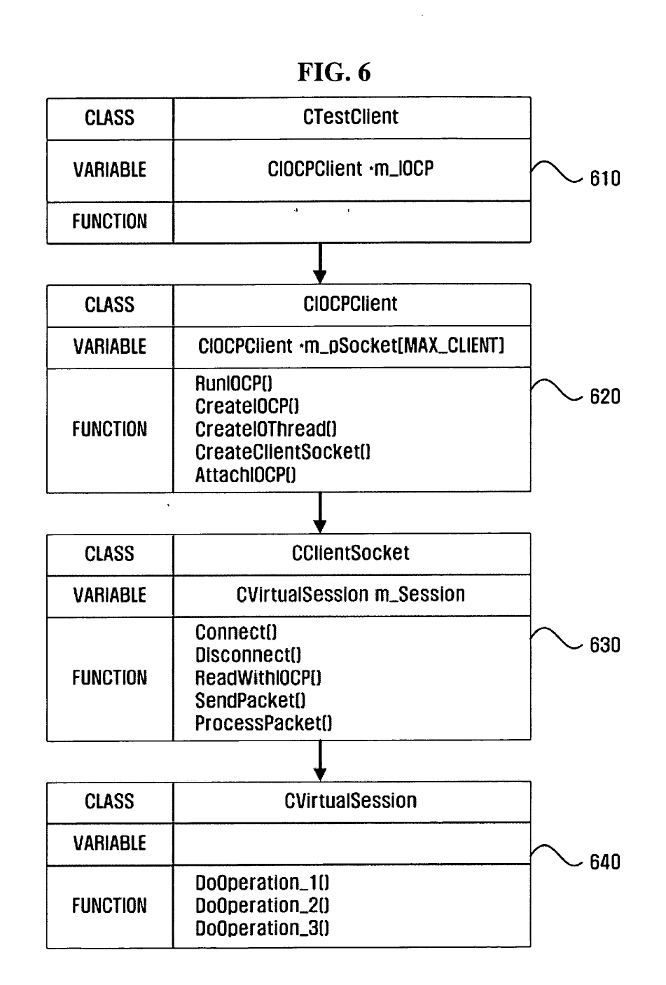

FIG. 6 is a diagram showing a structure of a class of an application program for measuring a capacity of a server according to an exemplary embodiment of the present invention.

The class of an application program for measuring a capacity of the server 220 includes an uppermost class CTestClient 610, CIOCPClient 620 that generates and manages the session managers 214 and the virtual clients 212, CClientSocket 630 that constitutes a session with the server 220, and CVirtualSession 640 that generates packets.

Referring to FIG. 6, CIOCPClient 620 is an upper class of CClientSocket 630 and can generate a plurality of virtual clients 212.

CIOCPClient 620 generates an asynchronous input output thread (the session manager 214), generates the virtual client 212, and processes scheduling between the session managers 214 and the virtual clients 212. CIOCPClient 620 is succeeded by CClientSocket 630, and a plurality of objects generated (virtual client 212) constitutes a session with the server 220, checks output of a packet from the packet queue, and makes the session manager 214 transmit the packet to the server 220.

CVirtualSession 640 succeeds CClientSocket 630 and generates a packet. Thus, since the session manager 214 can know whether the packet generated by CVirtualSession 640 is generated by the virtual client 212, the session manager 214 can transmit the packet to the server 220 through the session constituted by the virtual client 212.

CVirtualSession 640 can directly succeed CTestCleint 610 or CIOCPClient 620. In this case, the generated packet is not dependent on the virtual client 212, the session manager 214 cannot know the virtual client 212 that generates the packet. Thus, in this case, information (the session number) of the virtual client 212 is inserted into a header of the packet so that the session manager 214 can know the corresponding virtual client 212 of the packet during packet transmission using the session manager 214.

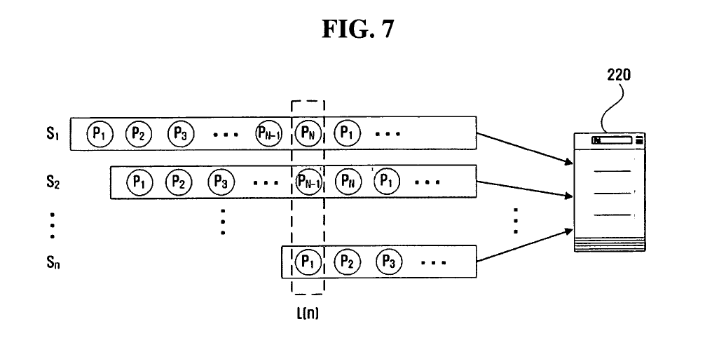

FIG. 7 shows a packet transmitted through each session according to an embodiment of the present invention.

A packet generated by the packet generating unit 310 according to a pattern of a packet per model is transmitted to the server 220 through each session. In this case, the number of a series of packets for each session varies. As shown in FIG. 7, after an N-th packet which is the last packet of a model is transmitted, a first packet is transmitted again.

Some time difference is provided between packet transmission through one session and packet transmission through another session. This is because a time for each instance required to set up network connection does not affect a test result.

To establish test conditions of traffic, the following assumptions are made:

Assumption 1: In a multi-thread operation environment, an overhead caused by context switching is the largest factor for hindering capacity.

Assumption 2: Ethernet network traffic has self-similarity.

Assumption 3: Working scheduling of threads using a synchronization unit is fair.

Assumption 4: There is no overhead caused by the use of memory, and when an operation using a synchronization unit is applied to network processing of a client for a model that does not include a scenario requiring long working time like database processing, the overhead is near 0.

Assumption 5: The size of data used in a general network processing server (packet data unit) is not large.

Under the assumptions, the sum L(n) of packets to be transmitted simultaneously when the packet is transmitted through a n-th session, which is the last session, is as follows:
L(n)={Pᵢ|1≦j≦n and i=j % N}.

Here, when data processing capacity is C [packets/sec], an overhead caused by CPU is O [sec/packet], the number of concurrent processing load packets is n, and thus, the time required for processing concurrent processing load L(n) is as follow:
T(n)=n×(1/C+O)

However, an overhead O is near 0 according to the fourth assumption, as shown in the following equation.
T(n)=n/C

Here, a data processing capacity C is a capacity of basic network input output and fixed on a specific platform.

To set quality of the apparatus 210 for measuring a capacity of a server according to the present exemplary embodiment, a service level agreement (SLA) may be applied.

When SLA for a response time required for processing a packet P is f_{SLA}(P), SLA for a response time required for processing one session S is as follows:

$${f}_{SLA} ( S ) = {\sum }_{i = 0}^{N} {f}_{SLA} ( {P}_{i} )$$

Thus, since a time required for concurrently processing load is n/C and the number of packets to be transmitted in each session is N, n that satisfies the following equation is the number of virtual clients that can be generated by the apparatus 210 for measuring a capacity of a server.

$$N \times ( \frac{n}{C} ) \leq {\sum }_{i = 0}^{N} {f}_{SLA} ( {P}_{i} )$$

Thus, the additional virtual clients may be generated manually or automatically even during operation of the apparatus. The apparatus 210 can inform a user whether SLA is satisfied or not, i.e., the virtual client 212 can or cannot be generated any more.

In addition, by using the above method, the apparatus 210 can inform the user if the number of the virtual client 212 (the number of virtual clients) has increased automatically to a certain number that last satisfies SLA or has reached the number desired by the user.

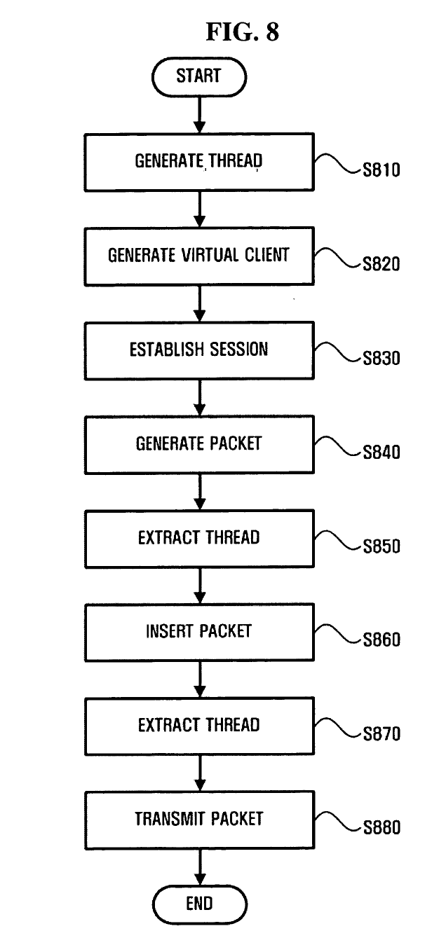

FIG. 8 is a flowchart illustrating a method of measuring a capacity of a server using the apparatus for measuring a capacity of a server according to an exemplary embodiment of the present invention.

First, the apparatus 210 for measuring a capacity of a server generates a thread in operation S810 and generates a virtual client 212 dependent on the thread in operation S820. Each virtual client 212 generated constitutes a session with the server 220 in operation S830 and makes the packet generating unit 310 generate a packet in operation S840.

When the packet is generated by the packet generating unit 310, the synchronization unit 330 extracts a thread, that has last been input and is in a standby state, among the threads stored in the thread unit 340 in operation S850. The extracted thread becomes a packet insertion session manager and inserts the generated packet into a packet queue in operation S860.

The packet insertion session manager is input back to the thread unit 340 using the synchronization unit 330.

While the operation of inserting the generated packet into the packet queue is continuously being performed, the synchronization unit 330 extracts a last input thread from the thread unit 340 for the operation. Due to extraction of a last input thread in a standby state using the synchronization unit 330, the frequencies of context switching between threads decrease.

If the packet is output from the packet queue, the synchronization unit 330 extracts again a last input thread (the session manager 214) in a standby state among the threads stored in the thread unit 340 in operation S870 and makes the thread to transmit the output packet to the server 220 in operation S880.

Since the session manager 214 processes the packet generated by the virtual client 212 dependent on the session manager 214 itself, the corresponding virtual client 212 can transmit the packet through the session that constitutes with the server 220.

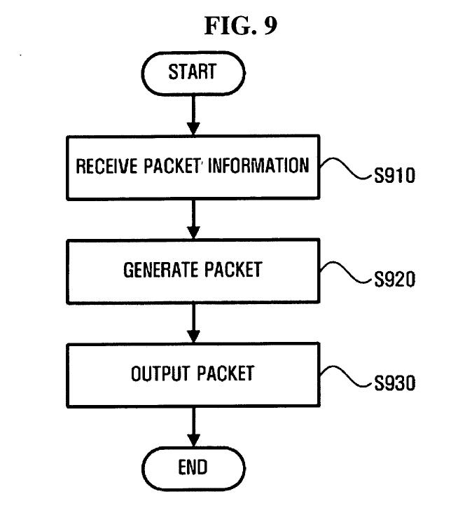

FIG. 9 is a flowchart illustrating a procedure of generating a packet according to an exemplary embodiment of the present invention.

The virtual client 212 constitutes a session with the server 220 and makes the packet generating unit 310 generate a packet. In this case, the type of packet models, the order of packets, and the session number are transmitted. The packet generating unit 310 can generate a corresponding packet using the type of packet models and the order of packets.

The input portion 420 of the packet generating unit 310 receives the type of model, the order of packets, and the session number from the virtual client 212 in operation S910. The received type of model, order of packets, and session number are transmitted to the controller 430. The controller 430 extracts corresponding packet information by referring to the storing portion 410 and generates a packet according to the information in operation S920.

The output portion 440 outputs the packet generated by the controller 430 in operation S930.

As described above, the apparatus and method for measuring a capacity of a server according to the present invention provide at least following advantages.

First, a plurality of virtual clients matched to a small number of threads are generated to minimize a context switching overhead such that the large amount of the virtual clients can communicate with a server.

Second, virtual clients transmit traffic similar to actual network traffic to the server such that a capacity of the server can be more accurately measured.

While the present invention has been particularly shown and described with reference to exemplary embodiments thereof, it will be understood by those skilled in the art that various changes in form and details may be made therein without departing from the spirit and scope of the invention as defined by the following claims and equivalents thereof.

What is claimed is:

1. An apparatus for measuring a capacity of a server, the apparatus comprising:
a packet generating unit which generates a packet;
an instance unit which generates a virtual client constituting a session with the server;
a thread unit which stores a thread transmitting the generated packet to the server through the constituted session; and
a synchronization unit which processes scheduling between the constituted session and the thread.

2. The apparatus of claim 1, wherein the packet generating unit comprises:
a storing portion which stores a pattern of the packet per model;
an input portion which receives a type of the model and an order of the packet;
a controller which generates the packet by referring to the received model type, the received packet order, and the stored pattern of the packet; and
an output portion outputting the generated packet.

3. The apparatus of claim 2, wherein the pattern comprises a size of the packet.

4. The apparatus of claim 3, wherein the size varies according to a predetermined model in an order of generation.

5. The apparatus of claim 2, wherein the input portion receives the type of the model and the order of the packets from the virtual client.

6. The apparatus of claim 5, wherein the virtual client further provides a session number to the input portion.

7. The apparatus of claim 1, wherein the instance unit generates the virtual client to the number required for satisfying predetermined conditions.

8. The apparatus of claim 1, wherein the thread unit comprises a thread queue formed in a stack shape, the thread queue storing the thread in a standby state.

9. The apparatus of claim 8, wherein the synchronization unit extracts the thread in an order of last-in-first-out.

10. The apparatus of claim 9, wherein the thread comprises:
a packet insertion session manager which inserts the generated packet into a packet queue; and
a packet transmission session manager which transmits the packet extracted from the packet queue.

11. The apparatus of claim 10, wherein the synchronization unit:
extracts the thread in the first place among threads stored in the thread unit when the packet is generated, if the thread is the last stored thread; and
returns the thread to the thread unit after inserting the generated packet into the packet queue.

12. The apparatus of claim 11, wherein the synchronization unit extracts another thread when another packet is generated, if the another thread is the second last stored thread among the threads and the first extracted thread has not been returned to the thread unit.

13. The apparatus of claim 1, wherein the number of threads stored in the thread unit is determined according to at least one of the number of central processing units of the server, the number of packet processing and the size of the packet.

14. A method of measuring a capacity of a server, the method comprising:
generating a packet;
generating a virtual client that constitutes a session with the server;
generating and storing a thread;
processing scheduling between the constituted session and the thread; and
transmitting the generated packet to the server through the constituted session.

15. The method of claim 14, wherein the generating of the packet comprises:
storing a pattern of the packet per model;
receiving a type of the model and an order of the packet;
generating the packet by referring to the model type, the received packet order, and the stored pattern of the packet; and
outputting the generated packet.

16. The method of claim 15, wherein the pattern comprises a size of the packet.

17. The method of claim 16, wherein the size varies according to a predetermined model in an order of generation.

18. The method of claim 15, wherein the type of the model and the order of the packet are received from the virtual client.

19. The method of claim 18, wherein the virtual client further provides a session number to the input portion.

20. The method of claim 14, wherein the generating of the virtual client comprises generating the virtual client to the number required for satisfying predetermined conditions.

21. The method of claim 14, wherein the thread is stored in a standby state in a thread unit comprising a thread queue formed in a stack shape.

22. The method of claim 21, wherein the processing of scheduling comprises extracting the thread in an order of last-in-first-out.

23. The method of claim 22, wherein the processing of scheduling further comprises:
inserting the generated packet into a packet queue; and
extracting the packet from the packet queue.

24. The method of claim 23, further comprising:
extracting the thread in the first place among threads stored in the thread unit when the packet is generated, if the thread is the last stored thread; and
returning the thread to the thread unit after inserting the generated packet into the packet queue.

25. The method of claim 24, further comprising:
extracting another thread when another packet is generated, if the another thread is the second last stored thread in the thread unit and the first extracted thread has not been returned to the thread unit.

26. The method of claim 14, wherein the number of threads stored in the thread unit is determined according to at least one of the number of central processing units of the server, the number of packet processing and the size of the packet.

27. The method of claim 14, further comprising setting up time difference between packet transmission through one session and packet transmission through another session so that a time for each session required to set up network connection to measure the capacity of the server does not affect a test result.
